(19) United States
(12) Patent Application Publication
(10) Pub. No.: US 2020/0007772 A1
(43) Pub. Date: Jan. 2, 2020

(54) IMAGING REPRODUCING METHOD AND APPARATUS

(71) Applicant: LG Electronics Inc., Seoul (KR)

(72) Inventors: Junyoung JUNG, Seoul (KR); Hyunkyu KIM, Seoul (KR); Kibong SONG, Seoul (KR); Chulhee LEE, Seoul (KR); Sangkyeong JEONG, Seoul (KR)

(21) Appl. No.: 16/557,953

(22) Filed: Aug. 30, 2019

(30) Foreign Application Priority Data
Aug. 19, 2019 (KR) 10-2019-0101419

(51) Int. Cl. H04N 5/232; H04N 5/217; G05D 1/02; H04N 5/14

(52) U.S. Cl. CPC H04N 5/23293; H04N 5/217; H04N 2005/44578; H04N 5/144; G05D 1/0246

(57) ABSTRACT

An image reproducing method and an image reproducing apparatus are disclosed. The image reproducing method to be performed during a video call includes receiving image information from a photographing terminal, acquiring first shaking information related to a reproducing terminal, identifying an output area to be displayed in the reproducing terminal from the image information by reflecting the first shaking information, and reproducing an image using the received image information and the identified output area. The image reproducing apparatus of the present disclosure may be linked to an Artificial Intelligence (AI) module, an Unmanned Aerial Vehicle (UAV), a robot, an Augmented Reality (AR) device, a Virtual Reality (VR) device, a 5G service-related device, etc.

### CROSS-REFERENCE TO RELATED APPLICATION

This application is based on and claims priority under 35 U.S.C. § 119(a) to Korean Patent Application No. 10-2019-0101419, which was filed on Aug. 19, 2019 in the Korean Intellectual Property Office, the disclosure of which is incorporated herein in its entirety by reference.

### BACKGROUND OF THE INVENTION

### Field of the Invention

The present disclosure relates to a technology for reproducing an image based on information related to movement of a movable object when an image is photographed in the object. The present disclosure relates to a technology by which a computation device reproduces an image by reflecting shaking of a transmission terminal and a reception terminal based on driving information of a vehicle, which is an movable object, while a video call is performed inside the vehicle.

### Related Art

Conventionally, since an image is generated by reflecting only shaking of a photographing terminal, there is a problem that shaking of the image cannot be calibrated precisely. In addition, while a video call is made inside a vehicle, shaking of an image is calibrated mainly around an object included in the image based on a difference in pixels from a previous frame among continuous frames, and thus, there is a problem that the shaking of the image cannot be reflected precisely. Such problems can become even worse when photographing and receiving images are performed in a moving object such as a vehicle. Therefore, there is need of a technology for reproducing an image which reflects shaking of the image in consideration of shaking of a terminal inside a moving object such as a vehicle.

### SUMMARY OF THE INVENTION

Embodiments disclosed in the present specification relates to a technology for reproducing an image by reflecting shaking of a photographing terminal and a reproducing terminal based on driving information of a vehicle while a video call is made inside the vehicle. A technical object of the present embodiments is not limited thereto, and other technical objects may be inferred from the following embodiments.

In one general aspect of the present invention, there is provided an image reproducing method performed by a reproducing terminal, the method including: receiving image information from a photographing terminal; acquiring first shaking information related to the reproducing terminal; identifying an output area to be displayed in the reproducing terminal from the image information by reflecting the first shaking information; and reproducing an image using the received image information and the identified output area.

In another general aspect of the present invention, there is provided an image reproducing apparatus including: a communication unit configured to receive image information from a photographing terminal; and a processor configured to acquire first shaking information related to a reproducing terminal, to identify an output area to be displayed in the reproducing terminal from the image information by reflecting the first shaking information, and to reproduce an image using the received image information and the output area.

Details of other embodiments are included in the detailed description and the accompanying drawings.

According to embodiments of the present specification, there are one or more effects as below.

First, there is an advantageous effect in that, while a video talk is made, shaking of an image can be calibrated in a reproducing terminal by reflecting a shaking vector that is derived from a shaking vector of a photographing terminal and a shaking vector of the reproducing terminal.

Second, there is an advantageous effect in that shaking of an image can be calibrated based on a driving situation while a video talk is made inside the vehicle.

Third, there is an advantageous effect in that, when shaking by a degree equal to or greater than a predetermined level is predicted based on a communication environment of the photographing terminal or a change in a driving situation, the reproducing terminal may identify relevant information in advance and thus may be prepared for shaking of an image.

However, the effects of the present disclosure are not limited to the above-mentioned effects, and effects other than the above-mentioned effects can be clearly understood by those of ordinary skill in the art from the following descriptions.

### BRIEF DESCRIPTION OF THE DRAWINGS

FIG. 1 shows an artificial intelligence (AI) device according to an embodiment of the present invention.

FIG. 2 shows an AI server according to an embodiment of the present invention.

FIG. 3 shows an AI system according to an embodiment of the present invention.

FIG. 4 is a diagram showing a photographing terminal and a reproducing terminal, which are necessary for a video call, according to an embodiment of the present invention.

FIG. 5 is a diagram showing a video call among a plurality of users through a vehicle according to an embodiment of the present invention.

FIG. 6 shows images before and after shaking is reflected in a photographing terminal according to an embodiment of the present invention.

FIG. 7 is a diagram showing a flowchart in which a transmission terminal transmits a shaking reflected image to a reception terminal according to an embodiment of the present invention.

FIG. 8 shows an image received by a reception terminal from a transmission terminal and an image in which shaking of the reception terminal is reflected according to an embodiment of the present invention.

FIG. 9 is a diagram showing a flowchart in which a reception terminal calibrates an image by reflecting shaking according to an embodiment of the present invention.

FIG. 10 is a diagram showing change in driving information or a communication environment according to an embodiment of the present invention.

FIG. 11 is a diagram showing information related to a photographing terminal displayed in a predetermined area of a reproducing terminal according to an embodiment of the present invention.

FIG. 12 is a flowchart showing a method for reproducing an image in which shaking is reflected according to an embodiment of the present invention.

FIG. 13 is a block diagram of an image reproducing apparatus according to an embodiment of the present invention.

### DESCRIPTION OF EXEMPLARY EMBODIMENTS

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

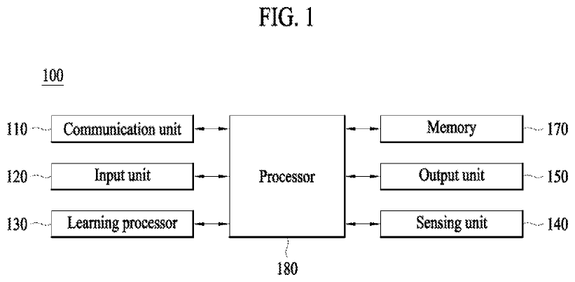

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

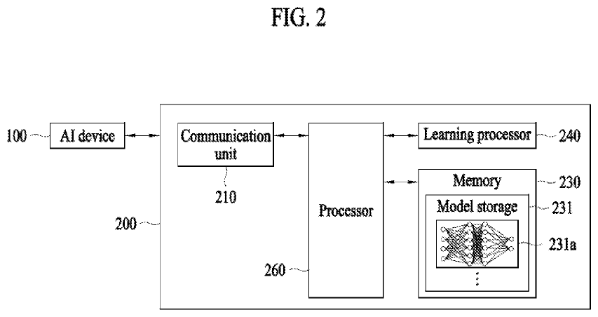

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

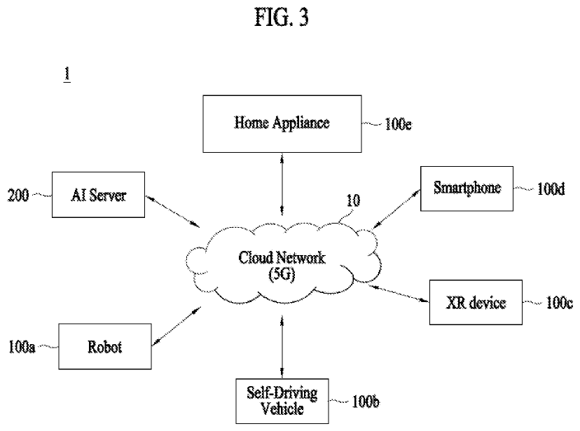

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

A robot 100a is subject to AI technologies, and may be realized as a guide robot, a transport robot, a cleaning robot, a wearable robot, an entertainment robot, a pet robot, an unmanned aerial vehicle, or the like.

The robot 100a may include a robot control module for controlling operation of the robot 100a, and the robot control module may refer to a software module or a chip for implementing the software module.

The robot 100a may acquire state information of the robot 100a using sensor information acquired from a variety of sensors, detect (recognize) a surrounding environment and a surrounding object, generate map data, determine a moving path and a driving plan, determine a response to a user interaction, or determine an operation.

Here, in order to determine a moving path and a driving plan, the robot 100a may utilize information acquired from at least one sensor of a lidar, a radar, and a camera.

The robot 100a may perform the aforementioned operations using a learning model composed of at least one artificial neural network. For example, the robot 100a may recognize a surrounding environment and a surrounding object using a learning model, and determine an operation using information on the recognized surrounding or the recognized object. Here, the learning model may be trained by the robot 100a or may be trained by an external device such as the AI server 200.

Here, the robot 100a may generate a result using the learning model and thereby perform an operation. Alternatively, an external device such as the AI server 200 transmits sensor information and the robot 100a may receive a result generated accordingly and thereby perform an operation.

The robot 100a may determine a moving path and a driving path using at least one of an object information detected from sensor information or object information acquired from an external device, and may drive the robot 100a in accordance with the determine moving path and the determined driving plan by controlling a driving unit.

Map data include object identification information regarding various objects placed in a space where the robot 100a moves. For example, the map data may include object identification information regarding fixed objects, such as a wall and a door, and movable object, such as a flower pot and a desk. In addition, the object identification information may include a name, a type, a distance, a location, etc.

In addition, the robot 100a may perform an operation or drive by controlling the driving unit based on a user's control or interaction. In this case, the robot 100 may acquire intent information of an interaction upon the user's operation or speaking, determine a response based on the acquired intent information, and perform an operation.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

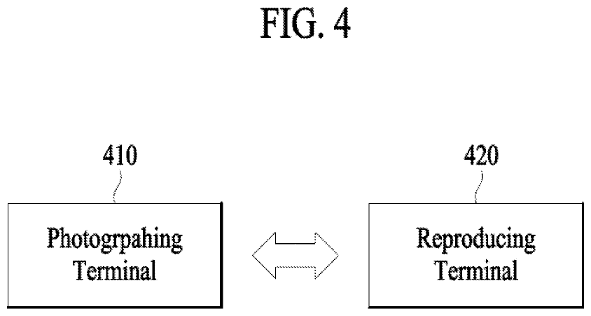

FIG. 4 is a diagram showing a photographing terminal and a reproducing terminal, which are necessary for a video call, according to an embodiment of the present invention.

A photographing terminal 410 and a reproducing terminal 420 may perform a video call using wireless/wired communications. Here, the photographing terminal 410 and the reproducing terminal 420 may include devices performing communications. In this case, since the photographing terminal 410 and the reproducing terminal 420 performs bidirectional communication, the photographing terminal 410 may transmit data and receive data from the reproducing terminal 420 at the same time, or the reproducing terminal 420 may receive data and transmit data from the photographing data 410 at the same time. For example, the photographing terminal 410 and the reproducing terminal 420 may include a mobile phone, a cellular phone, a smart phone, a personal computer (PC), a tablet computer, a wearable device, a laptop computer, a netbook, a personal digital assistant (PDA), a digital camera, a personal multimedia player (PMP), an E-book, a communication device installed in a vehicle, etc. Specifically, in a case where the photographing terminal 410 is a communication device installed in a vehicle where a sender is present and the reproducing terminal 420 is a communication device installed in a vehicle where a recipient is present, the respective vehicles may photograph the sender, the recipient and transmit relevant images to each other, and respectively display the images in a predetermined area in response to receiving the images. In this case, the photographing terminal 410 and the reproducing terminal 420 may perform a video call through wireless communication such as 5G communication, Wireless LAN (WLAN), Wireless Fidelity (WiFi) Direct, Digital Living Network Alliance (DLNA), Wireless broadband (Wibro), World Interoperability for Microwave Access (Wimax), High Speed Downlink Packet Access (HSDPA), Global System for Mobile communication (GSM), Code Division Multi Access (CDMA), WCDMA, 3GPP Long

Term Evolution (LTE), and 3GPP LTE Advanced (LTE-A) or may perform a video call through short-ranged communication such as Bluetooth™, Radio Frequency Identification (RFID), Infrared Data Association (IrDA), Ultra Wideband (UWB), ZigBee, and Near Field Communication (NFC).

When users present in the respective vehicles performs a video call using the photographing terminal 410 and the reproducing terminal 420, abrupt shaking may occur in the photographing terminal 410 and the reproducing terminal 420 according to driving situations of the respective vehicles. For example, when the users performs a video call using smart phones, abrupt shaking may occur in the photographing terminal 410 m based on a driving situation such as abrupt braking of a vehicle. In this case, an image transmitted to the reproducing terminal 420 may not include a sender due to the abrupt shaking of the photographing terminal 410. In a case where it is possible to estimate shaking of the photographing terminal 410 and the reproducing terminal 420 based on driving information of the vehicles, shaking of images transmitted and received between the photographing terminal 410 and the reproducing terminal 420 may be calibrated during a video call.

According to an embodiment, shaking of the photographing terminal 410 and the reproducing terminal 420 may be reflected and thus shaking of images may be calibrated. In this case, when the shaking of the photographing terminal 410 and the reproducing terminal 420 are estimated based on driving information of the photographing terminal 410 and the reproducing terminal 420, the reproducing terminal 420 may calibrate the shaking of the images by reflecting the estimated shaking of the photographing terminal 410.

In the present specification, the photographing terminal 410 may be a transmission terminal 420 that transmits image information, and the reproducing terminal 420 may be a reception terminal that receives the image information from the photographing terminal 410. Since bidirectional communication rather than unidirectional communication is performed, the roles of the photographing terminal 410 and the reproducing terminal may be changed to each other.

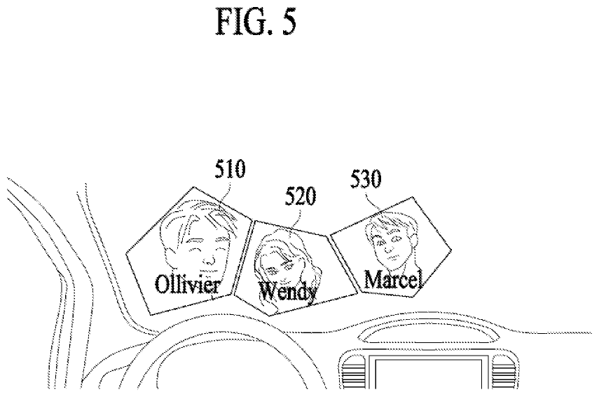

FIG. 5 is a diagram showing a video call among a plurality of users through a vehicle according to an embodiment of the present invention. Here, a photographing terminal may be a transmission terminal that transmits image information, and a reproducing terminal may be a reception terminal that receives the image information from the photographing terminal.

A transmission terminal and a plurality of reception terminals may perform a video call. Specifically, not just a 1:1 video call but also a video call among three or more users may fall into the scope of the present invention. As shown in FIG. 5, when a user makes a video call in a vehicle, images of other users 510, 520, and 530 may be output in a predetermined area. Here, the predetermined area may be an area where an image can be displayed, and the predetermined area may be, for example, a dashboard or a front windshield of the vehicle. In a case where the images of the other users 510, 520, and 530 are displayed on the front windshield, the images may be displayed in a manner of not disturbing the user's driving.

In this case, the predetermined area where the images of the other users 510, 520, and 530 are displayed may be changed during the video call. For example, in a case where the user 510 speaks, a size of a predetermined area regarding the user 510 may be relatively increased while the user 510 speaks or a preset color or transparency of the predetermined area regarding the user 510 may be changed. Accordingly, the user 510 who speaks more than the other users 520 and 520 among the plurality of users may be displayed distinctively. Alternatively, the predetermined area may be changed by the user's setting. For example, unlike the other users 510 and 520, the user may change the area where the other user 530 is displayed to a left hand-sided window.

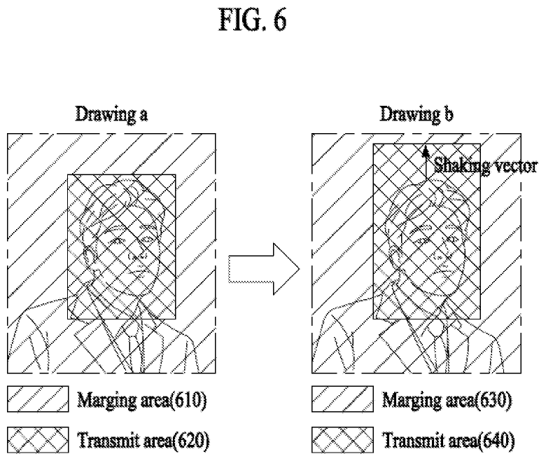

FIG. 6 shows images before and after shaking is reflected in a photographing terminal according to an embodiment of the present invention. Drawing A indicates an image before shaking is reflected in the photographing terminal, and Drawing B indicates an image after shaking is reflected in the photographing terminal. Here, the photographing terminal may be a transmission terminal that transmits image information, and a reproducing terminal may be a reception terminal that receives the image information from the photographing terminal.

An image photographed by the transmission terminal may include a margin area 610 and a transmit area 620. When shaking of the transmission terminal is reflected, the margin area 610 and the transmit area 620 are adjusted and thereby changed to a margin area 630 and a transmit area 640.

Here, the transmit area 640 may include an area where a user's face is located among image information of an interior of a vehicle, and the margin area 630 may include the other area except the transmit area 640.

In one embodiment, a computation device related to the photographing terminal may identify a transmit area in a photographed image. For example, the computation device may identify an area necessary to be transmitted from a photographed image and identify the identified area as a transmit area. For example, in the case of a video call, a transmit area may include an area where a user's face is located. In addition, a predetermined portion of a photographed picture may be determined as a transmit area, and a predetermined area in a central portion of the picture. Information regarding such a transmit area may include information on which area the transmit area is located in the photographed picture.

In addition, in one embodiment, the photographing terminal may transmit at least one of information on a photographed image or information regarding a transmitting image, information on a margin area, or shaking information of the photographing terminal. For example, the photographing terminal may acquire the information on the transmit area from the entire photographed area. For example, the photographing terminal may transmit the information on the transmit area and the information on the margin area, or the photographing terminal may transmit the information on the transmit area to the reception terminal while the reception terminal may identify other area except the transmit area as the margin area.

In addition, in one embodiment, the photographing terminal may transmit at least one of the image information or the shaking information of the photographing terminal. The reception terminal may identify an output area to be displayed on a screen and the margin area based on the transmitted information, and may display the image information by adjust the output area and the margin area based on the shaking information of the photographing terminal and the shaking information of the reception terminal. In one embodiment, identifying the output area by the reception terminal may be performed in a similar way of identifying a transmit area by the photographing terminal. For example, an area corresponding to a user's face in received image information may be determined as a transmit area. In another example, a specific portion in an image may be determined as a transmit area.

In addition, in one embodiment, when the photographing terminal is relevant to a vehicle, the shaking information of the photographing terminal may include driving relevant information of the vehicle. For example, information on a route along which the vehicle drives may be received in advance, and, when it is determined that shaking of a screen is greater than a predetermined standard thereafter, the computation device of the reception terminal may adjust a portion of an image which corresponds to the shaking.

In addition, in one embodiment, an output area may be determined based on at least one of the shaking information of the photographing terminal or the shaking information of the reception terminal. For example, when a degree of shaking is equal to or greater than a predetermined standard, a transmit area may be set to be wide. In this case, when intense shaking is predicted, an even wider area may be set as a transmit area so that a counterpart's face can be displayed within the transmit area, for example, during a video call.

In addition, in one embodiment, when the margin area and the transmit area are determined in the image information based on the shaking information of the photographing terminal, the reproducing terminal may adjust the margin area and the transmit area by additionally reflecting the shaking information of the reproducing terminal and may determine the margin area and the output area accordingly. In this case, the output area may be an area displayed through a display, and the margin area may be other area except the output area. Here, when a shaking vector, which is the shaking information of the photographing terminal and includes a shaking direction and a shaking intensity, is high, the transmit area may be determined to be large in consideration of the shaking intensity. Accordingly, the reproducing terminal may distinguish the transmit area, which is determined to be large, into a margin area and an output area by reflecting a shaking vector of the reproducing terminal, and the output area may be displayed through the display. For example, in a case where there are a shaking vector 1 and a relatively great shaking vector 2 in a curved road according to a speed of a vehicle in which the photographing terminal is included, a transmit area where the shaking vector 2 is reflected may be wider than a transmit area where the shaking vector 1 is reflected.

As such, as the photographing terminal transmits the above information to the reception terminal, the reception terminal may identify a part of an image reproduced in a display unit of the reception terminal. As such, since a part of an image reproduced in the display unit is determined based on shaking information of the photographing terminal or the reception terminal, a user of the reception terminal may be allowed to watch the image smoothly. The description about a margin area and a transmit area regarding the photographing terminal or a margin area and a transmit area regarding the reproducing terminal may equally apply to the following drawings.

Shaking of a transmission terminal may be determined based on driving information of a vehicle including the transmission terminal. Specifically, a driving route of the vehicle may be determined based on the driving information of the vehicle. Based on the driving route, the vehicle including the transmission terminal may identify a curved road predicted along the route. In this case, based on a curving degree of the curved road, shaking of the transmission terminal according to a speed of the vehicle may be predicted. Here, the driving route of the vehicle and/or a speed of the vehicle may be determined according to a statistical standard. For example, in a case where a U-shaped curve is included in the determined driving route for the vehicle, shaking of the transmission terminal when the vehicle drives the U-shaped curve at 60 km/h may be relatively lower than shaking of the transmission terminal when the vehicle drives the U-shaped curve at 100 km/h. If it is preset that there is no shaking of the transmission terminal even when the vehicle drives the U-shaped curve at 40 km/h, a shaking intensity and/or a shaking direction for a vehicle driving at 60 km/h and a vehicle driving at 100 km/h may be determined in comparison with the vehicle driving at 40 km/h. Here, the transmission terminal's not shaking when the vehicle drives the U-shaped curve at 40 km/h is merely an example of data that can be identified through a pre-statistical standard.

In addition, if irregularity of a road in which the vehicle is driving is sensed by a sensor embedded in the vehicle, shaking of the transmission terminal due to shaking of the vehicle may be predicted based on a degree of the irregularity. In this case, in a case where the shaking of the transmission terminal due to shaking of the vehicle is greater than a preset reference standard based on the degree of irregularity, a shaking intensity and/or a shaking direction according to the degree of the irregularity may be determined. Alternatively, in a case where the shaking of the transmission terminal is lower than the preset reference standard, the shaking may not be reflected in an image acquired by the transmission terminal. For example, in a case where the vehicle drives an unpaved mountain road, a degree of irregularity according to a condition of the unpaved road may be sensed. If upward and downward shaking of the vehicle is equal to or higher than 10 degrees according to the condition of the unpaved road, a shaking intensity and/or a shaking direction may be determined in comparison with a preset reference standard X at which shaking is not reflected in an image. Here, X is merely an example, and the preset reference standard X at which shaking is not reflected in an image may be identified through a pre-statistical standard.

In addition, if the vehicle's abrupt braking to be decelerated by a predetermined speed or more for a predetermined time is predicted according to a situation of the vehicle, the transmission terminal's shaking caused by the vehicle's shaking may be predicted based on a degree of the braking (for example, a degree of deceleration for the predetermined time). For example, if the vehicle's abrupt braking is predicted according to a driving situation of a surrounding vehicle, a degree of the abrupt braking may be estimated, and a shaking intensity and/or a shaking direction of the vehicle may be determined based on the degree of the abrupt braking. Specifically, in a case where the vehicle driving at 60 km/h is braked abruptly and in a case where the vehicle driving at 20 km/h is braked abruptly, shaking of the transmission terminal may be determined based on shaking of the vehicle according to a degree of abrupt braking.

A transmit area included in an image may be changed before and after shaking of the transmission terminal is reflected. As shown in Drawing A and

Drawing B, a shaking direction may be determined as an upward direction according to shaking of the vehicle. In addition, a shaking intensity may be determined according to the shaking of the vehicle, and a shaking vector may be determined according to the shaking direction and the shaking intensity. The transmit area may be changed by a degree as much as an area corresponding to the determined shaking vector, and the reception terminal may receive information relevant to the changed transmit area. In this case, the degree by which the transmit area is changed may be determined according to the shaking vector (the shaking direction and the shaking intensity).

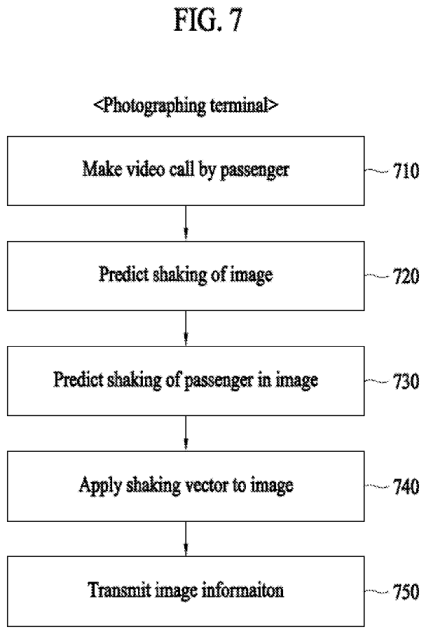

FIG. 7 is a diagram showing a flowchart in which a transmission terminal transmits a shaking reflected image to a reception terminal according to an embodiment of the present invention. Here, a photographing terminal may be the transmission terminal that transmits image information, and a reproducing terminal may be the reception terminal that receives the image information from the photographing terminal.

A user present in a vehicle may make a video call with the reception terminal using the transmission terminal (710). In this case, the transmission terminal may be an additional user terminal not embedded in the vehicle or may be a communication device embedded in the vehicle.

The transmission terminal may identify shaking of the vehicle based on driving information of the vehicle through wireless/wired communication with the vehicle. In this case, shaking of an image caused by shaking of the transmission terminal due to shaking of the vehicle may be predicted (720). If the transmission terminal is an additional user terminal not embedded in the vehicle, shaking of the transmission terminal inside the vehicle due to the shaking of the vehicle may be determined. In this case, whether the transmission terminal is fixed may be considered. If the transmission terminal is fixed, the shaking of the vehicle and the shaking of the transmission terminal may be identical. For example, in a case where the transmission terminal is fixed to a specific location in the vehicle, if the vehicle shakes upward and downward, the transmission terminal may equally shakes upward and downward. Therefore, shaking of an image caused by the shaking of the transmission terminal due to the shaking of the vehicle may be predicted. Alternatively, if the transmission terminal is not fixed, shaking of the transmission terminal inside the vehicle may be sensed by a sensor and a shaking direction and a shaking intensity for the transmission terminal may be determined based on the shaking of the transmission terminal sensed by the sensor. For example, in a case where a user is making a video call with holding the transmission terminal, a sensor inside the vehicle may sense a shaking direction and a shaking intensity according to movement of the transmission terminal in an image. Accordingly, shaking of the image caused by the shaking of the transmission terminal due to the shaking of the vehicle may be predicted.

When shaking of an image is predicted in the transmission terminal, shaking of an passenger in the image may be predicted (730). Due to shaking of the transmission terminal, the shaking of the passenger may be predicted based on a distance and/or an angle between a camera of the transmission terminal and the passenger. For example, shaking of the passenger in an image due to shaking of the transmission terminal may be predicted based on 50 cm and/or 45 degrees between the transmission terminal and the passenger. If a distance between the transmission terminal and the passenger is 1m, an intensity of the shaking of the passenger in the image may be increased even though the shaking occurs in the same transmission terminal. A shaking vector may be determined based on a shaking direction and a shaking intensity predicted for the passenger in the image.

The transmission terminal may apply the shaking vector to a transmit area (740). An image may include a margin area and a transmit area. In this case, the transmit area may e changed based on a shaking vector. For example, in a case where upward shaking is predicted, the transmit area may be increased upward as much as an intensity of the shaking. In this case, a variance of the transmit area may be determined based on the shaking vector. For example, if shaking with a greater intensity in the same direction occurs, a variance of the transmit area may be relatively high. In this case, the shaking vector may apply to the transmit area so that the image can be zoomed in, zoomed out or moved. For example, even though the passenger shakes in the image, whether the passenger exists in an existing transmit area may be sensed, and, if the passenger exists in the existing transmit area, the image may be moved based on a shaking vector. In another example, if it is predicted that the passenger shakes in the image and hence moves out of the existing transmit area, a shaking vector may apply so that the image can be zoomed out to include the passenger in the transmit area. In this case, a degree by which the image is zoomed out may be determined based on a shaking vector.

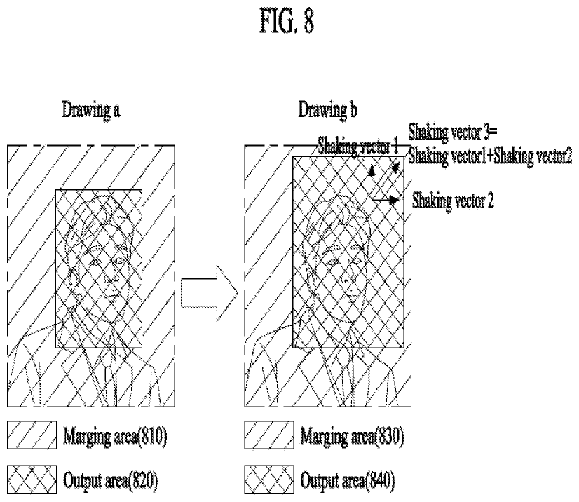

FIG. 8 shows an image received by a reception terminal from a transmission terminal and an image in which shaking of the reception terminal is reflected according to an embodiment of the present invention. A drawing a is an image received by a reception terminal from a transmission terminal, and a drawing b is an image in which shaking of the reception terminal is reflected. Here, a photographing terminal may be the transmission terminal that transmits image information, and a reproducing terminal may be the reception terminal that receives the image information from the photographing terminal.

The image received from the reception terminal from the transmission terminal may be an image in which shaking of the transmission terminal is reflected. The image received from the reception terminal may include the transmit area 640 except the margin area 630 in FIG. 6. The received image including the transmit area 530 may be differentiated into a margin area 810 and an output rea 820. In this case, the margin area and the output area may be adjusted in size based on a shaking vector 3, and the output area adjusted in size ay be displayed. In addition, in one embodiment, the received image may be an image photographed by the transmission terminal, and it is apparent that the reception terminal may display the output area by reflecting a degree of shaking.

The reception terminal may derive the shaking vector 3 based on shaking vector 1 of the transmission terminal and shaking vector 2 of the reception terminal. The shaking vector 3 may be determined by a sum of the shaking vector 1 and the shaking vector 2. The reception terminal may generate the margin area 30 and the output area 840 which are adjusted according to the derived shaking vector 3. Here, the output area 840 may be an area displayed in the reception terminal. As shown in drawing a and drawing b, a shaking direction may be determined, for example, as the direction of 1 o'clock according to the shaking vector 3 which is derived by considering shaking of the transmission terminal and the reception terminal. The output area may be changed according to the shaking vector 3, and the reception terminal may display the changed output area 840. In this case, a degree of change in the output area may be determined according to the shaking vector 3.

Here, the shaking vector 2 of the reception terminal may be determined by a vehicle including the reception terminal. The shaking vector 2 of the reception terminal may be transmitted to the transmission terminal that is making a video call. In this case, the transmission terminal may calibrate an image related to a recipient using the shaking vector 2 and display the calibrated image on a display. That is, the transmission terminal and the reception terminal may change the respective roles by bidirectional communication.

Specifically, a driving route of a vehicle may be determined based on driving information of the vehicle. Based on the determined driving route, the vehicle including the reception terminal may identify a curved road predicted along the route. In this case, shaking of the reception terminal according to the vehicle's speed may be predicted based on a curving degree of a curved road. Here, shaking of the vehicle based on the driving route of the vehicle and/or the speed of the vehicle may be determined according to a statistical standard. For example, in a case where an S-shaped curve is included in the determined driving route for the vehicle, shaking of the reception terminal while the vehicle driving the S-shaped curve at 80 km/h may be relatively lower than shaking of the reception terminal while the vehicle is driving the S-shaped curve at 120 km/h. In a case where it is preset such that there is no shaking in the reception terminal even when the vehicle drives the S-shaped curve at 30 km/h, a shaking intensity and/or a shaking direction for the vehicle driving at 80 km/h and the vehicle driving at 120 km/h may be determined in comparison with the vehicle driving at 30 km/h. Accordingly, the shaking vector 2 may be determined based on an intensity and/or a direction of shaking of the vehicle. Here, the vehicle's not shaking while driving the S-shaped curve at 30 km/h may be identified through a pre-statistical standard.

In addition, if irregularity of a road in which the vehicle is driving is sensed by a sensor embedded in the vehicle, shaking of the transmission terminal due to shaking of the vehicle may be predicted based on a degree of the irregularity. In this case, in a case where the shaking of the transmission terminal due to shaking of the vehicle is higher than a preset reference standard based on the degree of irregularity, a shaking intensity and/or a shaking direction according to the degree of the irregularity may be determined. Alternatively, in a case where the shaking of the transmission terminal is lower than the preset reference standard, the shaking may not be reflected in an image acquired by the transmission terminal. For example, in a case where the vehicle drives an unpaved mountain road, a degree of irregularity according to a condition of the unpaved road may be sensed. If upward and downward shaking of the vehicle is equal to or higher than 10 degrees according to the condition of the unpaved road, a shaking intensity and/or a shaking direction may be determined in comparison with a preset reference standard of 3 degrees at which shaking is not reflected in an image. Here, the 3 degrees is merely an example, and the preset reference standard by which shaking is not reflected in an image may be identified through a pre-statistical standard. Accordingly, the shaking vector 2 may be determined based on an intensity and/or a direction of shaking of the vehicle.

In addition, if the vehicle's abrupt braking to be decelerated by a predetermined speed or more for a predetermined time is predicted according to a situation of the vehicle, the transmission terminal's shaking caused by the vehicle's shaking may be predicted based on a degree of the braking. For example, if the vehicle's abrupt braking is predicted according to a driving situation of a surrounding vehicle, a degree of the abrupt braking may be estimated, and a shaking intensity and/or a shaking direction of the vehicle may be determined based on the degree of the abrupt braking. Accordingly, the shaking vector 2 may be determined based on an intensity and/or a direction of shaking of the vehicle.

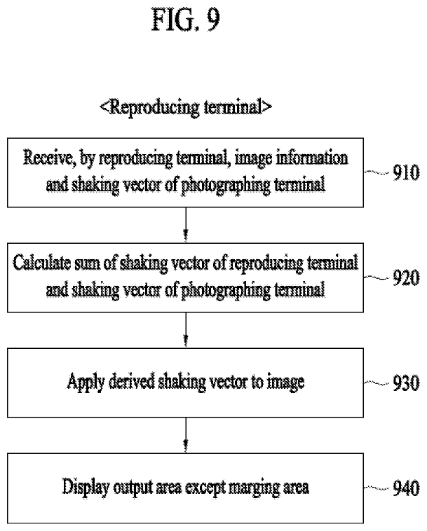

FIG. 9 is a diagram showing a flowchart in which a reception terminal calibrates an image by reflecting shaking according to an embodiment of the present invention. Here, a photographing terminal may be a transmission terminal that transmits image information, and a reproducing terminal may be a reception terminal that receives the image information from the photographing terminal.

A user present in a vehicle may make a video call with another user using a terminal. In this case, the transmission terminal may be an additional user terminal not embedded in the vehicle or may be a communication device embedded in the vehicle. In this case, the user's terminal is the reception terminal, the another user's terminal may be the transmission terminal. Alternatively, since the video call is real-time bidirectional communication, the transmission terminal and the reception terminal may change the respective roles to each other.

The reception terminal may receive an image and a shaking vector from the transmission terminal (910). In this case, the received image may be an image resulting from reflecting the shaking vector of the transmission terminal in an image acquired by the transmission terminal. In addition, the reception terminal may receive information related to driving information of a vehicle including the transmission terminal from the transmission terminal. The image transmitted by the transmission terminal and the shaking vector of the transmission terminal will be described in detail with reference to FIG. 7.

The reception terminal may derive shaking vector 3 based on shaking vector 1 of the transmission terminal and shaking vector 2 of the reception terminal (920). The shaking vector 3 may be determined by a sum of the shaking vector 1 and the shaking vector 2. The reception terminal may identify shaking of the vehicle including the reception terminal based on the driving information of the vehicle through wireless/wired communication with the vehicle. In this case, shaking of an image caused by shaking of the reception terminal due to the shaking of the vehicle may be predicted. If the reception terminal is an additional user terminal not embedded in the vehicle, shaking of the reception terminal inside the vehicle due to the shaking of the vehicle may be determined. In this case, whether the reception terminal is fixed may be considered. If the reception terminal is fixed, the shaking of the vehicle and the shaking of the reception terminal may be identical. For example, in a case where the reception terminal is fixed to a specific location in the vehicle, if the vehicle shakes upward and downward, the reception terminal may equally shakes upward and downward. Therefore, shaking of an image caused by the shaking of the reception terminal due to the shaking of the vehicle may be predicted. Alternatively, if the reception terminal is not fixed, shaking of the reception terminal inside the vehicle may be sensed by a sensor and a shaking direction and a shaking intensity for the reception terminal may be determined based on the shaking of the reception terminal sensed by the sensor. For example, in a case where a user is making a video call with holding the reception terminal, a sensor inside the vehicle may sense a shaking direction and a shaking intensity according to movement of the reception terminal in an image. The shaking vector 2 of the reception terminal due to the shaking of the vehicle may be determined. Accordingly, the reception terminal may derive the shaking vector 3 based on the determined shaking vector 2 and the shaking vector 1 received from the transmission terminal.

The transmission terminal may apply the shaking vector to a transmit area (930). An image may include a margin area and a transmit area. In this case, the transmit area may e changed based on a shaking vector. Accordingly, the margin area and the output area may be adjusted in size based on a shaking vector 3. In this case, the shaking vector may apply to the output area so that the image can be zoomed in, zoomed out or moved.

When the shaking vector 3 applies to the output area, the reception terminal may display the output area except the margin area in the image on the display (940). In addition, the reception terminal may transmit the output area to the transmission terminal. In addition, the transmission terminal may receive the shaking vector 2 and/or the shaking vector 3.

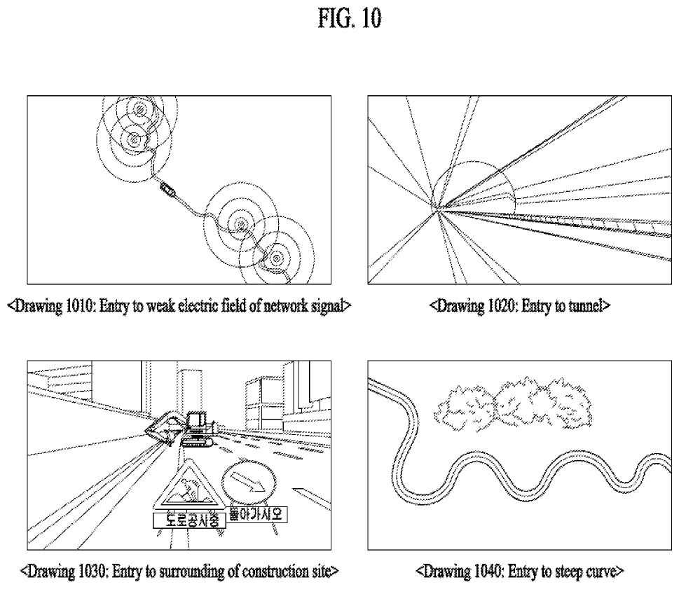

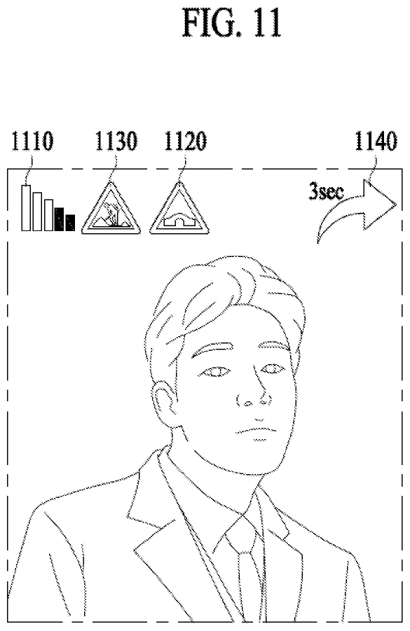

FIG. 10 is a diagram showing change in driving information or a communication environment according to an embodiment of the present invention. FIG. 11 is a diagram showing information related to a photographing terminal displayed in a predetermined area of a reproducing terminal according to an embodiment of the present invention. Here, a photographing terminal may be a transmission terminal that transmits image information, and a reproducing terminal may be a reception terminal that receives the image information from the photographing terminal.

Driving information or a communication environment of a vehicle including the transmission terminal may be shared with the reception terminal. The reception terminal may predict a change related to the transmission terminal, and reproduce an image that is calibrated based on the predicted change regarding the transmission terminal. Accordingly, the reception terminal may prepare in advance a change regarding the transmission terminal. Hereinafter, drawings 1010 to 1040 are merely examples of a change regarding the transmission terminal, and do not limit the scope of the present invention.

The drawing 1010 shows a case in which a vehicle including the transmission terminal has entered a place with a poor communication condition, communication between the transmission terminal and the reception terminal may not be performed smoothly. Accordingly, the transmission terminal may display, in a predetermined area, whether the transmission terminal has entered a place with a poor communication condition. In this case, the place with the poor communication condition refers to a place where a network signal connected to the transmission terminal is equal to or lower than a preset level. The drawing 1110 in FIG. 11 shows a network signal of the transmission terminal, which is displayed in a predetermined area of the reception terminal. Specifically, the drawing 1110 is an example in which intensity of a network signal upon entry to the transmission terminal into the place with the poor communication condition is displayed in the reception terminal. In this case, the predetermined area may be determined in advance or may be modified by a user's setting.

The drawing 1020 shows a case in which the vehicle including the transmission terminal has entered a tunnel based on driving information of the vehicle. If the presence of the tunnel is predicted according to a driving route of the vehicle, a scheduled tunnel entry time may be determined based on a speed of the vehicle. The transmission terminal may share the driving route and/or the scheduled tunnel entry time with the reception terminal, and the reception terminal may display the driving route and/or the scheduled tunnel entry time of the transmission terminal in a predetermined area. The drawing 1120 in FIG. 11 shows a case where the transmission terminal has entered a tunnel. Alternatively, a scheduled tunnel entry time of the transmission terminal may be displayed together.

The drawing 1030 shows a case where the vehicle including the transmission terminal enters a construction site. In the surroundings of the construction site, the transmission terminal may abruptly shake due to a poor road condition. In this case, a standard as to the surroundings of the construction site may be determined depending on whether the transmission terminal falls within a preset distance. If the transmission terminal approaches the construction site within the preset distance, the reception terminal may display a surrounding situation of the transmission terminal in a preset area. The drawing 1130 in FIG. 11 shows that the transmission terminal has entered the surroundings of the construction site. Alternatively, a scheduled construction site entry time of the transmission terminal may be displayed together.

The drawing 1040 shows a case in which the vehicle including the transmission terminal has entered a steep curve based on driving information of the vehicle. In the case where the vehicle has entered the steep curve, the transmission terminal may shake abruptly according to a speed of the vehicle. Shaking of the transmission terminal according to a curving degree of the curve and the speed of the vehicle may be predicted based on a pre-statistical standard, and the reception terminal may calibrate an image based on the predicted shaking of the transmission terminal. The drawing 1140 in FIG. 11 shows an example in which the transmission terminal enters a steep curve in three seconds.

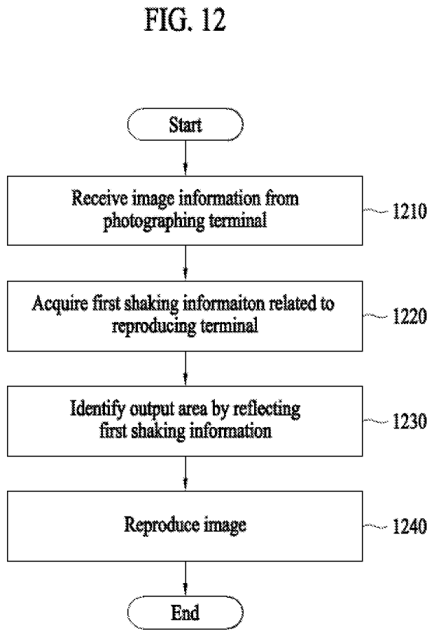

FIG. 12 is a flowchart showing a method for reproducing an image in which shaking is reflected according to an embodiment of the present invention. Here, a photographing terminal may be a transmission terminal that transmits image information, and a reproducing terminal may be a reception terminal that receives the image information from the photographing terminal.

In step 1210, image information may be received from the photographing terminal. Here, the image information may be information including an image of an interior of a vehicle including the transmission terminal. In this case, the received image information may be generated based on shaking information of the transmission terminal. The shaking information of the transmission terminal may be generated based on driving information of the vehicle. The image of the interior of the vehicle may be divided into a margin area and a transmit area, and the margin area and the transmit area may be adjusted depending on shaking of the transmission terminal. In addition, while receiving the image information from the transmission terminal, the reception terminal may receive the shaking information of the transmission terminal. Here, shaking information of the reception terminal (reproducing terminal) may be first shaking information, and shaking information of the transmission terminal (photographing terminal) may be second shaking information.

In step 1220, the first shaking information related to the reproducing terminal may be acquired. The shaking information of the reproducing terminal, that is, the reception terminal, may be determined based on driving information of a vehicle including the reproducing terminal. Shaking vector 3 may be derived based on shaking vector 1 of the transmission terminal and shaking vector 2 of the reception terminal.

In step 1230, an output area to be displayed in the reproducing terminal may be identified from the image information based on the first shaking information. In this case, the reception terminal may adjust the margin area and the output area in size by reflecting a new shaking vector derived from the first shaking information and the second shaking information in an image. If at least one of the first shaking information or the second shaking information is predicted according to the driving information of the vehicle to be adjusted by a predetermined degree or more in a predicted driving route of the vehicle, the output area may be adjusted and displayed by taking into consideration a degree of the predicted shaking.

In step 1240, the image may be reproduced using the image information and the output area. In addition, the reception terminal may display the driving information of the vehicle including the transmission terminal in a predetermined area or may display a change in a communication environment of the transmission terminal in a predetermined area. Accordingly, a user of the reception terminal is allowed to predict the shaking of the transmission terminal.

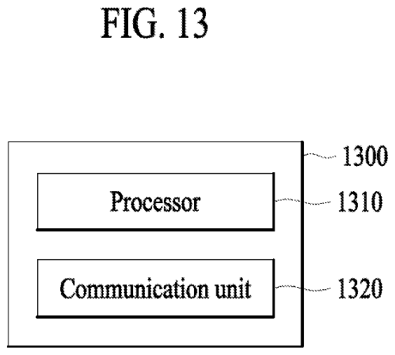

FIG. 13 is a block diagram of an image reproducing apparatus according to an embodiment of the present invention. Here, a photographing terminal may be a transmission terminal that transmits image information, and a reproducing terminal may be a reception terminal that receives the image information from the photographing terminal.

An image reproducing apparatus 1300 according to an embodiment of the present invention may include a processor 1310 and a communication unit 1320. The image reproducing apparatus 1300 may be embedded in the reception terminal or the transmission terminal. It is apparent to those skilled in the art that features and functions of the processor 1310 and the communication unit 1320 may correspond to those of the processor 180 and the communication unit 110 in FIG. 1.

The processor 1310 may generally control overall operations of the image reproducing apparatus 1300. For example, the processor 1310 may control overall operations of a communication unit, a display, etc. by executing programs stored in a memory (not shown).

In addition, when a video call is performed in a vehicle, the processor 1310 may reproduce an image by reflecting shaking of the image based on driving information of the vehicle. In this case, the image may be reproduced by reflecting not just shaking of the transmission terminal but also shaking of the reception terminal. In addition, the shaking of the transmission terminal and the shaking of the reception terminal are identified beforehand based on the driving information of the vehicle, and thus the image may be reproduced by taking into consideration of shaking of the image. In addition, when shaking of the transmission terminal being equal to or greater than a predetermined level due to a communication environment or a change in a driving situation is predicted, relevant information may be transmitted to the reception terminal and hence the reception terminal may be able to be prepared for the shaking of the image in advance.

The embodiments described above are illustrative examples and it should not be construed that the present invention is limited to these particular embodiments. Thus, various changes and modifications may be effected by one skilled in the art without departing from the spirit or scope of the invention as defined in the appended claims. While the present invention has been particularly shown and described with reference to an exemplary embodiment thereof, it will be understood by those skilled in the art that various changes in form and details may be made therein without departing from the spirit and scope of this invention as defined by the appended claims.

What is claimed is:

1. An image reproducing method performed by a reproducing terminal,
the method comprising:
receiving image information from a photographing terminal;
acquiring first shaking information related to the reproducing terminal;
identifying an output area to be displayed in the reproducing terminal from the image information by reflecting the first shaking information; and
reproducing an image using the received image information and the identified output area.

2. The image reproducing method of claim 1, further comprising receiving second shaking information related to the photographing terminal,
wherein the output area is identified by further considering the second shaking information.

3. The image reproducing method of claim 2,
wherein the image information comprises an image of an interior of a vehicle including the photographing terminal based on driving information of the vehicle, and
wherein the image information comprises a margin area and a transmit area, and the margin area and the transmit area are changed according to the second shaking information of the photographing terminal, which is measured based on the driving information of the vehicle including the photographing terminal.

4. The image reproducing method of claim 3, wherein the transmit area comprises an area where a user's face is located in the image information acquired by the photographing terminal regarding the interior of the vehicle, and the margin area comprises other area except the transmit area in the image information acquired by the photographing terminal regarding the interior of the vehicle.

5. The image reproducing method of claim 3,
wherein the transmit area and the margin area is variable in width,
wherein the second shaking information comprises a shaking direction and a shaking intensity of the photographing terminal, and
wherein the transmit area is increased as much as the shaking intensity in the shaking direction when the second shaking information is a relatively great number, compared with when the second shaking information is a small number.

6. The image reproducing method of claim 2,
wherein the reproducing of the image comprises adjusting the image information, received from the photographing terminal, based on new shaking information derived from the first shaking information and the second shaking information, determining a margin area and an output area, and displaying the output area, and
wherein the output area is an area to be reproduced through the reproducing terminal and the margin area is other area except the output area.

7. The image reproducing method of claim 2,
wherein the first shaking information of the reproducing terminal is determined by considering at least one of the following: driving information of a vehicle including the reproducing terminal, a distance between the reproducing terminal and an passenger, and an angle between the reproducing terminal and the passenger, and
wherein the second shaking information of the photographing terminal is determined by considering at least one of the following: driving information of a vehicle including the photographing terminal, a distance between the photographing terminal and an passenger, and an angle between the photographing terminal and the passenger.

8. The image reproducing method of claim 7, wherein the driving information of the vehicle is determined by considering at least one of the following: a curving degree of a curved road included in a driving route of the vehicle, a condition of a road in which the vehicle is driving, and a change in the speed of the vehicle.

9. The image reproducing method of claim 8, wherein when at least one of the first shaking information or the second shaking information is predicted, based on the driving information of the vehicle, to be adjusted by a degree equal to or higher than a predetermined standard in a predicted driving route, the output area is adjusted by a predicted shaking degree.

10. The image reproducing method of claim 1, wherein, in reproducing of the image,
when the photographing terminal has enters a place where an intensity of a network signal connected to the photographing terminal is equal to or lower than a predetermined reference standard, the intensity of the network signal is displayed together with the image;
when entry to a tunnel is scheduled along a driving route of the vehicle including the photographing terminal, information on the entry to the tunnel by the photographing terminal is displayed together with the image; or
driving information of the vehicle including the photographing terminal is displayed together with the image.

11. An image reproducing apparatus comprising:
a communication unit configured to receive image information from a photographing terminal; and
a processor configured to acquire first shaking information related to a reproducing terminal, to identify an output area to be displayed in the reproducing terminal from the image information by reflecting the first shaking information, and to reproduce an image using the received image information and the output area.

12. The image reproducing apparatus of claim 11,
Wherein the processor is further configured to receive second shaking information related to the photographing terminal,
wherein the output area is identified by further considering the second shaking information.

13. The image reproducing apparatus of claim 12,
wherein the image information comprises an image of an interior of a vehicle including the photographing terminal based on driving information of the vehicle, and
wherein the image information comprises a margin area and a transmit area, and the margin area and the transmit area are changed according to the second shaking information of the photographing terminal, which is measured based on the driving information of the vehicle including the photographing terminal.

14. The image reproducing apparatus of claim 13, wherein the transmit area comprises an area where a user's face is located in the image information acquired by the photographing terminal regarding the interior of the vehicle, and the margin area comprises other area except the transmit area in the image information acquired by the photographing terminal regarding the interior of the vehicle.

15. The image reproducing apparatus of claim 13,
wherein the transmit area and the margin area is variable in width,
wherein the second shaking information comprises a shaking direction and a shaking intensity of the photographing terminal, and
wherein the transmit area is increased as much as the shaking intensity in the shaking direction when the second shaking information is a relatively great number, compared with when the second shaking information is a small number.

16. The image reproducing apparatus of claim 12,
wherein the processor is further configured to:
adjust the image information, received from the photographing terminal, based on new shaking information derived from the first shaking information and the second shaking information,
determine a margin area and an output area, and
display the output area, and
wherein the output area is an area to be reproduced through the reproducing terminal and the margin area is other area except the output area.

17. The image reproducing apparatus of claim 12,
wherein the first shaking information of the reproducing terminal is determined by considering at least one of the following: driving information of a vehicle including the reproducing terminal, a distance between the reproducing terminal and an passenger, and an angle between the reproducing terminal and the passenger, and
wherein the second shaking information of the photographing terminal is determined by considering at least one of the following: driving information of a vehicle including the photographing terminal, a distance between the photographing terminal and an passenger, and an angle between the photographing terminal and the passenger.

18. The image reproducing apparatus of claim 17, wherein the driving information of the vehicle is determined by considering at least one of the following: a curving degree of a curved road included in a driving route of the vehicle, a condition of a road in which the vehicle is driving, and a change in the speed of the vehicle.

19. The image reproducing apparatus of claim 18, wherein the processor is further configured to:
when the photographing terminal has enters a place where an intensity of a network signal connected to the photographing terminal is equal to or lower than a predetermined reference standard, display the intensity of the network signal together with the image;
when entry to a tunnel is scheduled along a driving route of the vehicle including the photographing terminal, display information on the entry to the tunnel by the photographing terminal together with the image; or
display driving information of the vehicle including the photographing terminal together with the image.

20. A computer readable non-volatile recording medium in which an instruction for executing the method of claim 1 in a computer is recorded.
